(19) United States
(12) Patent Application Publication
(10) Pub. No.: US 2023/0127916 A1
(43) Pub. Date: Apr. 27, 2023

(54) Vehicle Monitoring System

(71) Applicant: Dominique Hunt, Williamsville, NY (US)

(72) Inventor: Dominique Hunt, Williamsville, NY (US)

(21) Appl. No.: 17/511,313

(22) Filed: Oct. 26, 2021

(51) Int. Cl. B60R 25/10; B60R 25/102; B60R 25/30; B60R 11/04

(52) U.S. Cl. CPC B60R 25/1012; B60R 25/102; B60R 25/305; B60R 25/302; B60R 11/04; B60R 2025/1016; B60R 2011/0005

(57) ABSTRACT

The disclosed vehicle Camera System captures live video and audio to ensure driver protection. Vehicle Camera System introduces a novel, high-quality, vehicle camera system to be mounted on multiple parts of the vehicle, including on the dashboard, side-view mirrors, rear-view mirror, and rear of the vehicle. These cameras are activated as soon as the user pushes the wireless GPS tracking operator button down. The button is located on the inside of the steering wheel and enables the entire system with no abrupt movement. The Vehicle Camera System ensures a fully operational, vehicle camera recording system, and, therefore, guarantees that no victim is wrongfully convicted and is capable of providing exact evidence of the events that occur.

### BACKGROUND

A dashboard camera or simply dashcam, also known as car digital video recorder (car DVR), driving recorder, or event data recorder (EDR), is an onboard camera that continuously records the view through a vehicle's front windscreen and sometimes rear or other windows. Some dashcams include a camera to record the interior of the car in 360 degrees inside camera, usually in a ball form, and can automatically send pictures and video using 4G.

EDRs and some dashcams also record acceleration/deceleration g-force, speed, steering angle, GPS data, etc. A wide-angle 130, 170° or more front camera may be attached to the interior windscreen, to the rear-view mirror (clip on), or to the top of the dashboard, by suction cup or adhesive-tape mount. A rear camera is usually mounted in the rear window or in the registration plate, with a RCA video output to the display monitor/screen.

The resolution will determine the overall quality of the video. Full HD or 1080p (1920×1080) is standard for dash HD cams. Dash cameras may have 1080p, 1296p, 1440p, or higher definition for a front camera and 720p for a back camera and include f/1.8 aperture and night vision mode.

Dashcams can provide video evidence in the event of a road accident. When parked, dashcams can capture video and picture evidence if vandalism is detected by 360° parking monitor and send it to the owner usually employing 4G.

### SUMMARY OF THE INVENTION

The main purpose of Vehicle Camera System is to capture live video and photo evidence from a vehicle to ensure driver protection at all times. An average of fifty million car accidents happen globally per year. In many occasions, drivers are unable to accurately describe the cause of the incident because of lack of evidence to either prove innocence or depict the actions that occur in accident scenes. Victims of car ambushes and abductions are also at a great risk, considering many are unable to identify the offenders to get justice. Vehicle Camera System introduces a novel, high-quality, vehicle camera system to be mounted on multiple parts of the car, including on the dashboard, side-view mirrors, rear-view mirror, and rear of the vehicle. These cameras are activated as soon as the user pushes the wireless GPS tracking operator button down. The button is located on the inside of the steering wheel and enables the entire system with no abrupt movement. The Vehicle Camera System ensures a fully operational, vehicle camera recording system, and, therefore, guarantees that no victim is wrongfully convicted and is capable of providing exact evidence of the events that occur.

The disclosed vehicle monitoring system includes multiple cameras wirelessly connected and configured to share an activation by a common switch, a wireless internet router for the plurality of cameras to interconnect and to intraconnect to other devices and a controller configured to announce the activation and to transmit a feed thereof on the wireless internet router and to record the feed.

### BRIEF DESCRIPTION OF THE DRAWINGS

FIG. 1 depicts locations of cameras in multiple views of a vehicle, in accordance with an embodiment of the present disclosure.

FIG. 2 depicts alternate locations of cameras, in multiple views of a vehicle, in accordance with an embodiment of the present disclosure.

FIG. 3 is a component block diagram of modules in the disclosed vehicle monitoring system in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

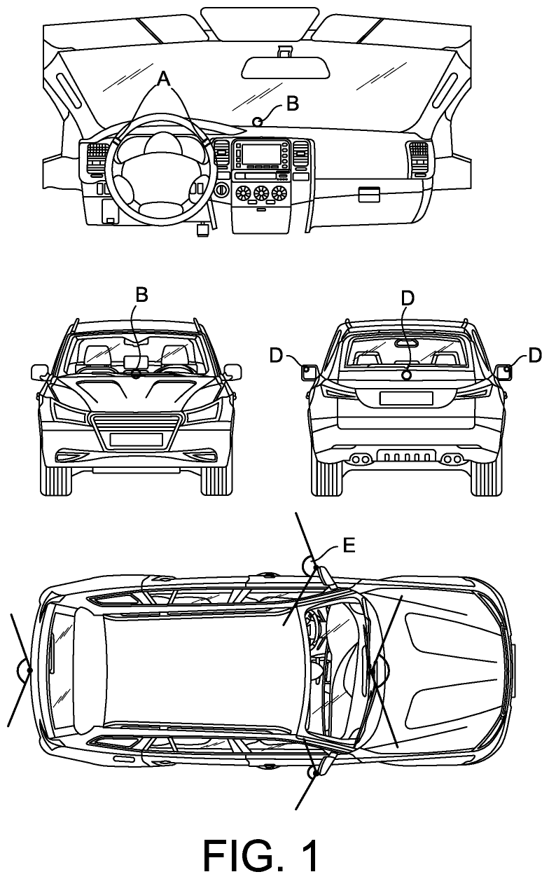

FIG. 1 depicts locations of cameras in multiple views of a vehicle, in accordance with an embodiment of the present disclosure.

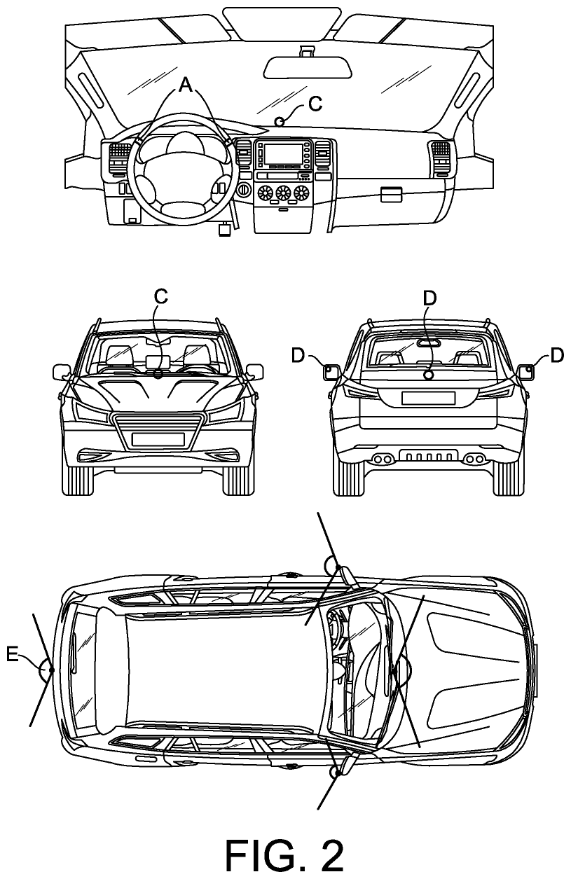

FIG. 2 depicts alternate locations of cameras, in multiple views of a vehicle, in accordance with an embodiment of the present disclosure.

Reference A depicts the wireless activation switch. Reference B depicts the one-hundred-sixty-degree, 1080p, live video, motion activated, wireless, motion-activated, night-vision camera for outside or inside use. The camera also has a built-in microphone for recording audio. Reference C depicts a camera with the same functionality as Reference B. Reference D depicts a camera with the same functionality as Reference B. Reference E depicts the one-hundred-sixty-degree cone of vision for the cameras.

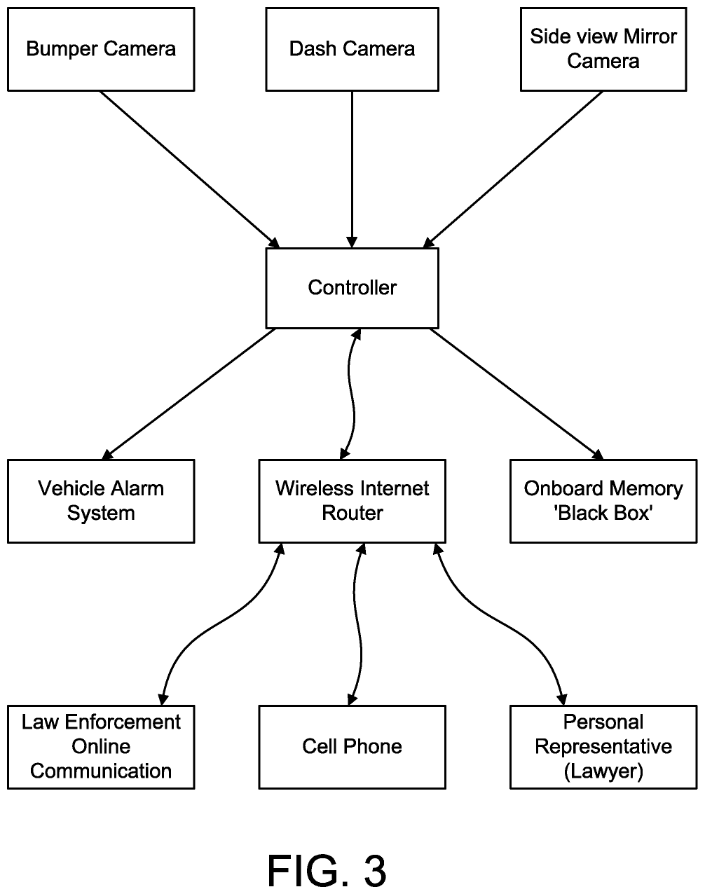

FIG. 3 is a component block diagram of modules in the disclosed vehicle monitoring system in accordance with an embodiment of the present disclosure. The component modules include one or more bumper cameras, a dash camera and one or more sideview mirror cameras. The component modules also include a controller onboard the vehicle and housed in a fire resistant and tamper resistance ‘black box,’ discrete to the disclosed system and randomly placed to avoid detection. The component modules also include an interconnected vehicle alarm system and an intraconnected memory for recording of a streaming audio and visual record stamped with a GPS (global positioning satellite) geographic location of the vehicle. The component modules also include a wireless internet router for transmitting wireless signals to law enforcement agencies of interest and contract, cell phone(s) of interest and contract and personal representatives online including but not limited to attorneys, officers, friends and relatives of the user of the disclosed system.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A vehicle monitoring system comprising:
a plurality of cameras wirelessly connected and configured to share an activation by a common switch;
a wireless internet router for the plurality of cameras to interconnect and to intraconnect to other devices; and
a controller configured to announce the activation and to transmit a feed thereof on the wireless internet router and to record the feed.

2. The vehicle monitoring system of claim 1 wherein the common switch is a wireless mechanical switch disposed on a steering wheel of the vehicle.

3. The vehicle monitoring system of claim 1, wherein the plurality of cameras include a plurality of wirelessly connected microphones activated by the common switch.

4. The vehicle monitoring system of claim 1, wherein the plurality of cameras include a plurality of wirelessly connected speakers configured to share the feed.

5. The vehicle monitoring system of claim 1, wherein the common switch is a wireless voice activated switch.

6. The vehicle monitoring system of claim 1, wherein the common switch is a wireless motion activated switch having a 180 degree field of view from a dash of the vehicle.

7. The vehicle monitoring system of claim 1, wherein the plurality of wireless cameras are interconnected to a security system of the vehicle

8. The vehicle monitoring system of claim 1, wherein the other devices comprise a monitor screen, a cell phone and an alarm proximal the vehicle.

9. The vehicle monitoring system of claim 1, wherein the activation announcement comprises an audible alarm.

10. The vehicle monitoring system of claim 1, further comprising a signage indicating a live video stream capability on board the vehicle.

11. The vehicle monitoring system of claim 1, wherein the feed is a digital stream output from the plurality of cameras including a GPS (global positioning satellite) location stamp.

12. The vehicle monitoring system of claim 1, wherein the record of the feed is accomplished via a memory on board the vehicle in a discrete fire resistant metallic housing.

13. The vehicle monitoring system of claim 1, wherein the controller is configured to transmit the feed to a law enforcement agency online.

14. The vehicle monitoring system of claim 1, wherein the controller is configured to transmit the feed to a public forum online.

15. The vehicle monitoring system of claim 1, wherein the plurality of cameras are disposed on a front bumper and on a rear bumper of the vehicle.

16. The vehicle monitoring system of claim 1, wherein the plurality of cameras are mounted on side view mirrors and a rear view mirror of the vehicle.

17. The vehicle monitoring system of claim 1, wherein one of the plurality of cameras is mounted on a front dash of the vehicle.

18. The vehicle monitoring system of claim 1, wherein at least one of the plurality of cameras has a field of view internal to the vehicle.

19. The vehicle monitoring system of claim 1, further comprising a fire resistant discrete housing on board the vehicle to house the controller.

20. The vehicle monitoring system of claim 1, wherein the wireless internet router is contained in a fire resistant discrete housing on board the vehicle.
